(19) United States
(12) Patent Application Publication
(10) Pub. No.: US 2012/0167805 A1
(43) Pub. Date: Jul. 5, 2012

(54) METHOD OF IMPROVING GYPSUM BOARD STRENGTH

(76) Inventors: James R. Wittbold, Des Plaines, IL (US); Bruce L. Petersen, Lisle, IL (US); David R. Blackburn, Barrington, IL (US)

(21) Appl. No.: 13/339,699

(22) Filed: Dec. 29, 2011

Related U.S. Application Data
(60) Provisional application No. 61/427,862, filed on Dec. 29, 2010.

(51) Int. Cl. C04B 11/00

(52) U.S. Cl. 106/677

(57) ABSTRACT

One or more of these or other problems are improved using a method of making a strong gypsum panel which includes a method for forming a hardened shell structure at the interface of a foamed bubble and a gypsum slurry. A strengthening component is selected from the group consisting of set accelerators, water soluble polyphosphate salts, blends of water soluble polyphosphate salts with starch, boric acid, fibers, glycerin or combinations thereof. The strengthening component is combined with a foaming agent and with water to form an aqueous soap mixture. Foam is generated from the aqueous soap mixture, and added to a gypsum slurry. Allowing the strengthening component to contact the soap bubbles prior to addition of the foam to the gypsum slurry allows the strengthening component to preferentially contact the soap film rather than be dispersed through the entire slurry.

### RELATED APPLICATION

This application claims priority under 35 USC 119(e) from U.S. Provisional Application Ser. No. 61/427,862 filed Dec. 29, 2010.

### FIELD OF THE INVENTION

This invention relates to a method of strengthening gypsum boards. More specifically, it relates to creating a shell around foam bubbles that are added to a gypsum slurry to strengthen the bubble walls.

### BACKGROUND

Gypsum panels or boards are widely used as building materials. Wallboard made of gypsum is fire retardant and can be used in the construction of walls of almost any shape. It is used primarily as an interior wall or exterior wall or ceiling product. Gypsum has sound-deadening properties. It is relatively easily patched or replaced if it becomes damaged. There are a variety of decorative finishes that can be applied to the wallboard, including paint and wallpaper. Even with all of these advantages, it is still a relatively inexpensive building material.

One reason for the low cost of wallboard panels is that they are manufactured by a process that is fast and efficient. Calcium sulfate hemihydrate hydrates in the presence of water to form a matrix of interlocking calcium sulfate dihydrate crystals, causing it to set and to become firm. A slurry that includes the calcium sulfate hemihydrate and water is prepared in a mixer. When a homogeneous mixture is obtained, the slurry is continuously deposited on a moving surface that optionally includes a facing material. A second facing material is optionally applied thereover before the slurry is smoothed to a constant thickness and shaped into a continuous ribbon. The continuous ribbon thus formed is conveyed on a belt until the calcined gypsum is set, and the ribbon is thereafter cut to form panels of desired length, which panels are conveyed through a drying kiln to remove excess moisture. Since each of these steps takes only minutes, small changes in any of the process steps can lead to gross inefficiencies in the manufacturing process.

The amount of water added to form the slurry is in excess of that needed to complete the hydration reaction. Excess water gives the slurry sufficient fluidity to flow out of the mixer and onto the facing material to be shaped to an appropriate width and thickness. As the product starts to set, the water pools in the interstices between dihydrate crystals. The hydration reaction continues building the crystal matrix in and around the pools of water, using some of the pooled water to continue the reaction. When the hydration reactions are complete, the unused water occupying the pools leaves the matrix by evaporation. Interstitial voids are left in the gypsum matrix when all water has evaporated. The interstitial voids are larger and more numerous where large amounts of excess water are used.

Those who install gypsum panels become fatigued by continuously moving and lifting the panels. It is, therefore advantageous to make panels that are lightweight for ease in handling. Lightweight panels can be made by adding foam to the gypsum slurry. A foaming agent, such as soap, can be added to the slurry so that foam is produced by the mixing action. In some cases, the foaming agent is used to pregenerate a foam that is added to the slurry before or after it exits the mixer. The foaming agent is selected to produce a foam that is actively coalescing while hydration is taking place. A distribution of foam bubble sizes results from an “active” foam. As the hydration reactions proceed, the gypsum matrix builds up around the foam bubbles, leaving foam voids in the matrix when the set gypsum forms and the foam bubbles break.

It can be difficult to obtain a distribution of foam voids that results in an acceptable panel strength. Ideal foams are “active” foams that generate small bubbles that coalesce to continuously produce a distribution of large and small bubbles. Foam voids that are very small and numerous have very thin walls of gypsum matrix between them. Poor compressive strength of the finished panel may result. Formation of very large foam voids can produce unevenness in the surface of the panel, making it aesthetically unacceptable. Additives that are used in the slurry can further cause the foam bubbles to become excessively unstable, quickly coalescing in to large bubbles. Other additives, including some polycarboxylate dispersants, stabilize the foam too much, so that small bubbles fail to combine. Producing a foam having the proper balance of bubble size to make a strong gypsum panel has been shown to be a difficult task.

### SUMMARY

One or more of these or other problems are improved using a method of making a strong gypsum panel which includes a method for forming a hardened shell structure at the interface of a foamed bubble and a gypsum slurry. A strengthening component is selected from the group consisting of set accelerators, water soluble polyphosphate salts, sodium tri-metaphosphate, blends of water soluble polyphosphate salts with starch, boric acid, fibers, glycerin and combinations thereof. The strengthening component is then combined with a foaming agent and with water to form an aqueous soap mixture. Foam is generated from the aqueous soap mixture, and then added to a gypsum slurry. The particular order of the combination steps referred to above is not considered critical to the present method and alternate sequences of steps are contemplated.

In some embodiments, the method described above further results in a more cost-effective use of additives compared to adding them to the gypsum slurry. By including the strengthening component in the foam water, the foaming agent, the aqueous soap mixture and/or the foam, the additive contacts the gypsum only in the location where it does the most good. When the foam is combined with the gypsum slurry, the slurry surrounds the foam bubble that is infused with the strengthening component. As the slurry hardens and sets, it absorbs the water from the foam bubble, ultimately breaking the bubble which results in a relatively high concentration of the additive on, or in close proximity to, the inside surface of the void left by the bubble. In another embodiment, a method for forming a hardened shell structure at the interface of a foamed bubble and a gypsum slurry, includes: selecting a strengthening component, combining a foaming agent and the strengthening component with water to form an aqueous soap mixture, generating a foam from the aqueous soap mixture; and adding the foam to a gypsum slurry comprising a hydraulic component, wherein, a gypsum board is formed from the slurry, the board having increased strength compared to board lacking the strengthening agent in the foam.

### DETAILED DESCRIPTION

The improved gypsum panel is made by first combining a foaming agent, a strengthening component and foam water to make a foam prior to its addition to a gypsum slurry. Separate preparation of the foam places the strengthening component directly into the foam, not in the gypsum slurry where it is diluted and/or in competition with other components for access to the soap bubbles.

In embodiments of the invention that employ a foaming agent to yield foam voids in the set gypsum-containing product to provide lighter weight, any of the conventional foaming agents known to be useful in preparing foamed set gypsum products can be employed. Many such foaming agents are well known and readily available commercially, such as the HYONIC line of soap products from GEO Specialty Chemicals, Ambler, Pa. Any foaming agents are useful alone or in combination with other foaming agents.

An example of a combination of foaming agents includes a first foaming agent which forms a stable foam and a second foaming agent which forms an unstable foam. The first foaming agent is optionally a soap with an alkyl chain length of 8-12 carbon atoms and an ethoxy group chain length of 1-4 units. The second foaming agent is optionally an unethoxylated soap with an alkyl chain length of 6-16 carbon atoms. Regulating the respective amounts of these two soaps allows for control of the panel foam void structure until 100% stable soap or 100% unstable soap is reached. Exemplary combinations of foaming agents and their addition to foamed gypsum products are disclosed in U.S. Pat. No. 5,643,510, herein incorporated by reference.

Another component of the foam is the strengthening component. This component is selected to strengthen the shell around the void left by the foam bubble. When the foam and calcined gypsum slurry are combined, the slurry coats the outside of the bubble. As hydration of the calcium sulfate hemihydrate proceeds, reaction with water converts it to calcium sulfate dihydrate. The water is primarily drawn from the slurry, but for hemihydrate crystals adjacent to a foam bubble, water from the foam will also be absorbed. When the strengthening component is added to any one of the foaming agent, the water, or the foam, and the foam is generated apart from the gypsum slurry, a stronger structure is obtained after board made from the slurry is produced. The strength enhancer is concentrated in the foam bubbles rather than being distributed throughout the gypsum slurry. When combined with the gypsum slurry, the strength enhancer is then concentrated in the bubble film. Proximity of the strength component to the forming gypsum matrix strengthens the structure where needed to form a strong shell around the foam void.

Examples of the strengthening component include glycerin, set accelerators, boric acid, strength-enhancing polymers known in the art, starches and blends thereof and phosphate salts, such as sodium tri-metaphosphate, other water soluble polymetaphosphate salts, fibers or combinations thereof. Strengthening components are used in amounts of about 0.25 to 3.5%, based on weight of stucco. Fibers could also be used in combination with one of the other strengthening componends to add integrity to the void wall.

While not wishing to be bound by theory, different types of strengthening components are believed to act in different ways to strengthen the void walls. Salts can become part of the gypsum matrix, enhancing board strength by linking crystals together. Fibers act to reinforce the gypsum matrix in the vicinity of the void wall. Starch acts as a binder to hold the crystals of calcium dihydrate together. Regardless of the mechanism, any strengthening component or combinations thereof may be used.

Crystalline set accelerators, such as coated or uncoated landplaster, act as seed crystals to reduce the induction time of the reaction. Crystalline accelerators are used in amounts of up to about 35 lb./MSF (170 g/m2). “CSA” is a set accelerator comprising 95% calcium sulfate dihydrate co-ground with about 5% (weight percent) sugar and heated to 250° F. (121° C.) to caramelize the sugar. CSA is available from USG Corporation, Southard, Okla. plant, and is made according to U.S. Pat. No. 3,573,947, herein incorporated by reference. Potassium sulfate, aluminum sulfate and sodium bisulfate are also suitable accelerators. HRA is calcium sulfate dihydrate freshly ground with sugar at a ratio of about 5 to 25 pounds of sugar per 100 pounds of calcium sulfate dihydrate. HRA is further described in U.S. Pat. No. 2,078,199, herein incorporated by reference. Both of these are preferred accelerators. These set accelerators decrease hydration time and decrease fluidity.

Another preferred accelerator is known as wet gypsum accelerator or WGA. A description of the use of, and a method for making wet gypsum accelerator are disclosed in U.S. Pat. No. 6,409,825, herein incorporated by reference. This accelerator includes at least one additive selected from the group consisting of an organic phosphonic compound, a phosphate-containing compound or mixtures thereof. Wet gypsum accelerator exhibits substantial longevity and maintains its effectiveness over time such that the wet gypsum accelerator can be made, stored, and even transported over long distances prior to use. The wet gypsum accelerator is used in amounts ranging from about 5 to about 80 pounds per thousand square feet (24.3 to 390 g/m²) of board product.

The foam is pregenerated from the aqueous soap mixture. One method of making the foam is using a foam generator that mixes the soap solution with air. Any method of mixing can be used to combine the soap with air that causes bubbles to be formed, including agitation, turbulent flow or mixing. The amount of water and air are controlled to generate foam of a particular density. Adjustment of the foam volume is used to control the overall dry product weight.

If desired, a mixture of foaming agents can be pre-blended “off-line”, i.e., separate from the process of preparing the foamed gypsum product. However, it is preferable to blend the first and second foaming agents concurrently and continuously, as an integral “on-line” part of the mixing process. This can be accomplished, for example, by pumping separate streams of the different foaming agents and bringing the streams together at, or just prior to, a foam generator that is employed to generate the stream of aqueous foam which is then inserted into and mixed with the calcined gypsum slurry. By blending in this manner, the ratio of the first and second foaming agents in the blend can be simply and efficiently adjusted (for example, by changing the flow rate of one or both of the separate streams) to achieve the desired void characteristics in the foamed set gypsum product. Such adjustment will be made in response to an examination of the final product to determine whether such adjustment is needed. Further description of such “on-line” blending and adjusting can be found in U.S. Pat. Nos. 5,643,510 and 5,683,635, previously incorporated by reference. In a similar manner, the strengthening agent may be pre-blended with foaming agents or foam water off-line, or may be added as a separate component at any stage of the foam generation process.

The prepared foam is then added to a gypsum slurry that includes a hydraulic component. Any form of calcined gypsum may be used, including but not limited to alpha or beta stucco. Use of calcium sulfate anhydrite, synthetic gypsum or landplaster is also contemplated. Other hydraulic materials, including cement and fly ash, are optionally included in the slurry.

Water is added to the slurry in any amount that makes a flowable slurry. The amount of water to be used varies greatly according to the application with which it is being used, the dispersant being used, the properties of the stucco and the additives being used. The water to stucco ratio (“WSR”) with wallboard is preferably about 0.1 to about 1.2 based on the dry weight of the stucco. In some embodiments, a WSR of about 0.4 to about 0.9 is preferred. In other embodiments, a WSR of about 0.7 to about 1.2 is used. The WSR can even be reduced further in laboratory tests based on the moderate addition of certain dispersants.

Water used to make the slurry should be as pure as practical for best control of the properties of both the slurry and the set gypsum. Salts and organic compounds are well known to modify the set time of the slurry, varying widely from accelerators to set inhibitors. Some impurities lead to irregularities in the structure as the interlocking matrix of dihydrate crystals forms, reducing the strength of the set product. Product strength and consistency is thus enhanced by the use of water that is as contaminant-free as practical.

Some additives to a gypsum slurry affect the bubble size distribution of the foam when they are combined. Different polycarboxylate dispersants, for example, can either stabilize or destabilize the foam. Additives that tend to stabilize the foam include certain PCE dispersants, while napthlalene sulfonate and certain starches tend to destabilize the foam cells. Stable foams are those that are long lasting with bubbles typically remaining more or less constant in size. Bubbles that coalesce with each other and grow larger are unstable. The effects of these additives should be considered when choosing the type or amount of strengthening component to add.

Void size distribution of the foamed gypsum core can be finely controlled by adjusting the concentration of the soaps in the aqueous soap mixture. After a foamed gypsum core has been prepared, inspection of the interior of the gypsum core reveals the void structure. Changes in the void size distribution are produced by varying the soap concentration from the initial or previous concentration. If the interior has too large a fraction of small voids, the soap concentration in the aqueous soap mixture can be reduced. If too many very large, oblong or irregularly shaped voids are found, the soap concentration can be increased. Although the optimum void size distribution may vary by product, location or raw materials used, this process technique is useful to move towards the desired void size distribution, regardless of how it is defined. The desirable void size distribution in many embodiments is one that produces a high strength core for the gypsum formulation being used.

The slurry and the pregenerated foam are combined to make a foamed gypsum composition. One method of combining the gypsum slurry and the pregenerated foam is by pressurizing the foam and forcing it into the slurry. At least one embodiment uses a foam ring to distribute the foam. The foam ring is a shaped apparatus that allows the slurry to flow through it. It includes one or more jets or slots for discharge of the pressurized foam into the slurry as the slurry passes the ring. Use of a foam ring is disclosed in U.S. Pat. No. 6,494,609, herein incorporated by reference. Another method of combining the foam and the slurry is by addition of the foam directly to the mixer. In one embodiment, a foam ring or other foam injecting apparatus is oriented to inject foam into the discharge conduit of the mixer. This process is described in commonly-assigned U.S. Pat. No. 5,683,635, incorporated by reference. Regardless of the way that the foam is generated or introduced into the slurry, an important feature of the present method is that the strengthening agent is combined or added at some point in the foam production or generation prior to its introduction into the slurry. The gypsum composition is shaped to form a gypsum core.

### Example 1

Gypsum casts were produced in the laboratory using various additives to the foam water. A gypsum slurry was prepared from 600 grams calcium sulfate hemihydrate (USG, Southard, Okla.) with 2 grams CSA, sufficient water to provide 0.75 water/stucco ratio (gauge water plus foam water), 0.15% naphthalene sulfonate dispersant preblended in gauge water (dry basis, as a percent of stucco) and an aqueous foam solution consisting of the following: 0.5% PFM 33 stable soap, 0.5% STMP, and 0.25 to 2.0% by weight of the aqueous foam solution, of a starch material as shown in Table 1.

The laboratory mixing sequence and procedure follows:

1. Water with dispersant is placed in the Hobart mixer bowl.

2. Stucco pre-blended with accelerator is added to the bowl and soaked for a short time before the mechanical mixing begins.

3. Materials are mixed using Hobart mixer. During mixing, foam is added for density control. The amount of foam addition was determined experimentally as the amount needed to produce dry density of 42.5 pcf, +/−1.7 pcf.

For each of the tests listed below for comparing the performance of various strength enhancing agents, the following parameters were held substantially constant: accelerator amount, dispersant amount, dry density target, and core void distribution.

TABLE I

| Set Number | Additive | Generic Name | Manufacturer | Amount |
|---|---|---|---|---|
| 1 | Control | | | |
| 2 | N-Tack | Waxy Corn | National Starch | 1% |
| | | Starch | | |
| | | derivative | | |
| 3 | N-Tack | Waxy Corn | National Starch | 2% |
| | | Starch | | |
| | | derivative | | |
| 4 | K 4484 | Tapioca dextrin | National Starch | 1% |
| 5 | Clintose | Refined | ADM | 1% |
| | | dextrose | | |
| | | monohydrate | | |
| 6 | Clintose | Refined | ADM | 2% |
| | | dextrose | | |
| | | monohydrate | | |
| 7 | 14227-30C | Dextrin | National Starch | 1% |
| 8 | Hibond | Acid modified | Bunge | 1% |
| | | Corn flour | | |
| 9 | National 104 | Pregelatinized, | National Starch | 1% |
| | | modified starch | | |
| 10 | Special | Wheat starch | ADM | 1% |
| | Edge | and hydrolyzed | | |
| | | starch | | |
| 11 | Control | | | |
| 12 | Control | | | |
| 13 | N-Tack | Waxy corn | National Starch | 2% |
| | | starch | | |
| | | derivative | | |
| 14 | Hibond | Acid modified | Bunge | 0.5% |
| | | corn flour | | |
| 15 | Hibond | Acid modified | Bunge | 0.25% |
| | | corn flour | | |
| 16 | 30B | Dextrin | National Starch | 1% |
| 17 | SDU-E | Wheat starch | ADM | 1% |

Each sample set included six samples. Every sample was tested for physical properties including density and compressive strength. The average and standard deviation over all six samples is reported below in Table II.

TABLE II

| | |
|---|---|
| | Compressive |
| | Strength |
| | pounds force |
| Density (pcf) | on a 2″ cube |

| Sample Set | Avg. | Std. Dev. | Avg. | Std. Dev. |
|---|---|---|---|---|
| 1 | 43.49 | 0.20 | 2587 | 62 |
| 2 | 42.08 | 0.49 | 2653 | 150 |
| 3 | 43.43 | 0.91 | 2977 | 285 |
| 4 | 42.50 | 0.12 | 2759 | 111 |
| 5 | 42.58 | 0.22 | 2702 | 96 |
| 6 | 42.48 | 0.12 | 2611 | 139 |
| 7 | 41.03 | 0.97 | 2466 | 185 |
| 8 | 44.12 | 0.33 | 3267 | 202 |
| 9 | 43.25 | 0.09 | 2660 | 151 |
| 10 | 43.66 | 0.37 | 2860 | 171 |
| 11 | 43.14 | 0.26 | 2695 | 85 |
| 12 | 42.87 | 0.33 | 2388 | 77 |
| 13 | 42.75 | 0.28 | 3079 | 223 |
| 14 | 43.65 | 0.14 | 3113 | 184 |
| 15 | 43.67 | 0.23 | 2963 | 102 |
| 16 | 42.73 | 0.11 | 2846 | 105 |
| 17 | 43.92 | 0.43 | 2874 | 227 |

These tables show that significant differences in the strength of the board can be achieved by additives to the foam water. Products having a higher density have higher strength. At similar densities, some of the test samples above have significantly higher compressive strength. For example, control sample 1 and sample 14 using 0.5% Hibond have similar densities, but the addition of Hibond results in about a 20% average increase in the compressive strength from 2581 to 3113 lb/ft³. This is a difference of almost three standard deviations, demonstrating the statistical significance of the results. Thus, by adding the strengthening agent to the foam before it is added to the gypsum slurry allows a reduction in the amount of additives. Also, by adding the strengthening agent in this manner, the agent is more effectively placed at an interface of the foam bubble and the surrounding slurry.

While a particular embodiment of the method of improving gypsum board strength has been shown and described, it will be appreciated by those skilled in the art that changes and modifications may be made thereto without departing from the invention in its broader aspects and as set forth in the following claims.

What is claimed is:

1. A method for forming a hardened shell structure at the interface of a foamed bubble and a gypsum slurry, comprising:
selecting a strengthening component from the group consisting of set accelerators, water soluble polyphosphate salts, blends of water soluble polyphosphate salts with starch, boric acid, fibers, glycerin or combinations thereof;
combining a foaming agent and the strengthening component with water to form an aqueous soap mixture;
generating a foam from the aqueous soap mixture; and
adding the foam to a gypsum slurry comprising a hydraulic component.

2. The method of claim 1 wherein said foaming agent comprises a stable soap.

3. The method of claim 2 wherein said foaming agent further comprises an unstable soap.

4. The method of claim 1 wherein said foaming agent comprises an unstable soap.

5. The method of claim 1 wherein said strengthening component is present in amounts of about 0.25 to about 3.5% based on the weight of the hydraulic component.

6. The method of claim 1 wherein the strengthening component of said selecting step is selected from the group consisting of blends of sodium tri-metaphosphate and starch, sodium tri-metaphosphate, glycerin, boric acid and combinations thereof.

7. The method of claim 1 wherein the aqueous soap mixture of said combining step is free of other components.

8. A method for forming a hardened shell structure at the interface of a foamed bubble and a gypsum slurry, comprising:
selecting a strengthening component;
combining a foaming agent and the strengthening component with water to form an aqueous soap mixture;
generating a foam from the aqueous soap mixture; and
adding the foam to a gypsum slurry comprising a hydraulic component,
wherein, a gypsum board is formed from the slurry, the board having increased strength compared to board lacking the strengthening agent in the foam.

9. The method of claim 8 wherein said strengthening component is sodium tri-metaphosphate.

10. The method of claim 8 wherein said adding of the foam is performed by inserting the foam into a discharge conduit of a mixer used for mixing the gypsum slurry.
